(19) United States
(12) Patent Application Publication
(10) Pub. No.: US 2002/0019860 A1
(43) Pub. Date: Feb. 14, 2002

(54) Method and apparatus for distributed administration of thin client architecture

(76) Inventors: Gene F. Lee, Mountain View, CA (US); David C. Lopata, Sugar Hill, GA (US); John F. Greenberg, Warwick, NY (US)

Correspondence Address: J.D. Harriman II, COUDERT BROTHERS, 23rd Floor, 333 South Hope Street, Los Angeles, CA, 90071, US

(21) Appl. No.: 09/813,487

(22) Filed: Mar. 21, 2001

Related U.S. Application Data
(60) Provisional application No. 60/222,408, filed on Aug. 2, 2000.

(51) Int. Cl. G06F 15/177

(52) U.S. Cl. 709/220; 709/223

(57) ABSTRACT

The present invention provides a method and apparatus for distributed administration of thin client architecture. In one embodiment of the present invention, administrative tasks are accomplished by multiple administrators. In one embodiment, the number of administrative tasks assigned to an administrator is approximately uniform throughout the computer system. In this embodiment, creation of multiple user accounts is accomplished by assigning each administrator a roughly equal number of user accounts to create. Workgroup administration is accomplished similarly. In one embodiment, students are users and teachers are administrators.

### BACKGROUND OF THE INVENTION

1. Field of the Invention

The present invention relates to the field of systems administration, and in particular to a method and apparatus for distributed administration of thin client architecture.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

In computer systems administration, it is frequently necessary to add or remove users as well as create and modify privileges for groups of users. Current computer administration schemes, however, are inadequate, specifically in situations where it is desirable for large numbers of administrative tasks to be accomplished in a limited amount of time. Before further discussing the drawbacks of current prior art schemes, an application architecture where this problem typically occurs is described below.

Multi-Tier Application Architecture

In the multi-tier application architecture, a client communicates requests to a server for data, software and services, for example, and the server responds to the requests. The server's response may entail communication with a-database management system for the storage and retrieval of data.

The multi-tier architecture includes at least a database tier that includes a database server, an application tier that includes an application server and application logic (i.e., software application programs, functions, etc.), and a client tier. The data base server responds to application requests received from the client. The application server forwards data requests to the database server.

FIG. 1 provides an overview of a multi-tier architecture. Client tier 100 typically consists of a computer system that provides a graphic user interface (GUI) generated by a client 110, such as a browser or other user interface application. Conventional browsers include Internet Explorer and Netscape Navigator, among others. Client 110 generates a display from, for example, a specification of GUI elements (e.g., a file containing input, form, and text elements defined using the Hypertext Markup Language (HTML)) and/or from an applet (i.e., a program such as a program written using the Java™ programming language, or other platform independent programming language, that runs when it is loaded by the browser).

Further application functionality is provided by application logic managed by application server 120 in application tier 130. The apportionment of application functionality between client tier 100 and application tier 130 is dependent upon whether a “thin client” or “thick client” topology is desired. In a thin client topology, the client tier (i.e., the end user's computer) is used primarily to display output and obtain input, while the computing takes place in other tiers. A thick client topology, on the other hand, uses a more conventional general purpose computer having processing, memory, and data storage abilities. Database tier 140 contains the data that is accessed by the application logic in application tier 130. Database server 150 manages the data, its structure and the operations that can be performed on the data and/or its structure.

Application server 120 can include applications such as a corporation's scheduling, accounting, personnel and payroll applications, for example. Application server 120 manages requests for the applications that are stored therein. Application server 120 can also manage the storage and dissemination of production versions of application logic. Database server 150 manages the database(s) that manage data for applications. Database server 150 responds to requests to access the scheduling, accounting, personnel and payroll applications' data, for example.

Connection 160 is used to transmit data between client tier 100 and application tier 130, and may also be used to transfer the application logic to client tier 100. The client tier can communicate with the application tier via, for example, a Remote Method Invocator (RMI) application programming interface (API) available from Sun Microsystems™. The RMI API provides the ability to invoke methods, or software modules, that reside on another computer system. Parameters are packaged and unpackaged for transmittal to and from the client tier. Connection 170 between application server 120 and database server 150 represents the transmission of requests for data and the responses to such requests from applications that reside in application server 120.

Elements of the client tier, application tier and database tier (e.g., client 110, application server 120 and-database server 150) may execute within a single computer. However, in a typical system, elements of the client tier, application tier and database tier may execute within separate computers interconnected over a network such as a LAN (local area network) or WAN (wide area network).

Administration in Thin Client Architectures

Some administrative tasks in thin client architectures include creating user accounts, removing user accounts, creating workgroups, modifying privileges associated with workgroups and removing workgroups. In prior art administration schemes, execution of administrative tasks is accomplished by a centralized administrator. In computer systems, the number of pending administrative tasks is large. Sometimes, computer systems require so much administrative attention that a single administrator cannot provide enough attention. Prior art schemes have failed to address this problem. As such, the administrator cannot catch up with the backlog of administrative tasks causing significant delays in completion of administrative tasks.

### SUMMARY OF THE INVENTION

The present invention provides a method and apparatus for distributed administration of thin client architecture. In one embodiment of the present invention, administrative tasks are accomplished by multiple administrators. In one embodiment, the number of administrative tasks assigned to an administrator is approximately uniform throughout the computer system. In this embodiment, creation of multiple user accounts is accomplished by assigning each administrator a roughly equal number of user accounts to create. Workgroup administration is accomplished similarly. In one embodiment, students are users and teachers are administrators.

### BRIEF DESCRIPTION OF THE DRAWINGS

These and other features, aspects and advantages of the present invention will become better understood with regard to the following description, appended claims and accompanying drawings where:

FIG. 1 is a block diagram of an overview of a multi-tier architecture.

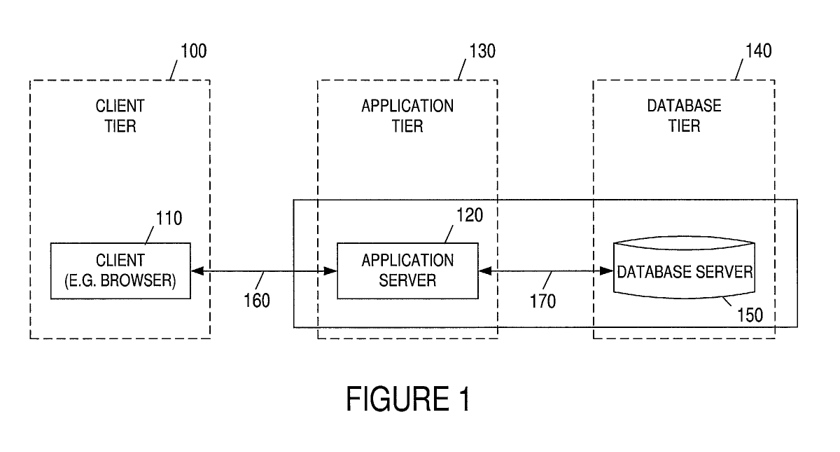

FIG. 2 is a flow diagram of the process of administrative task execution in accordance with one embodiment of the present invention.

FIG. 3 is a flow diagram of the process of administrative task execution in accordance with one embodiment of the present invention.

FIG. 4 is a flow diagram of the process of administration of groups of users in accordance with one embodiment of the present invention.

FIG. 5A is a flow diagram of the process of systems administration in accordance with one embodiment of the present invention.

FIG. 5B is a flow diagram of the process of accessing an account form multiple locations in accordance with one embodiment of the present invention.

FIG. 6 is a block diagram of a thin client topology called a virtual desktop system architecture.

FIG. 7 is a block diagram of a virtual desktop system.

FIG. 8 is a block diagram of a human interface device.

FIG. 9 is a block diagram of a human interface device.

FIG. 10 is a block diagram of a general purpose computer.

### DETAILED DESCRIPTION OF THE INVENTION

The invention is a method and apparatus for distributed administration of thin client architecture. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

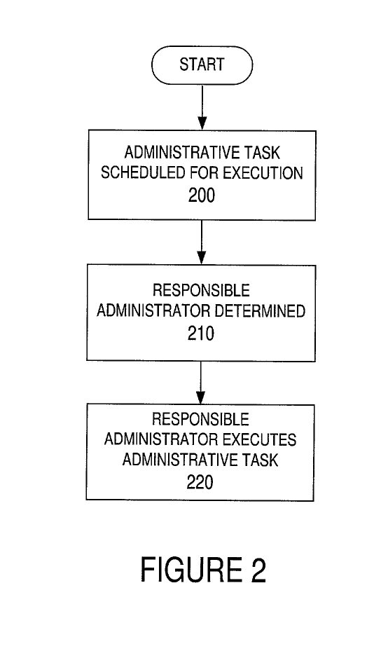

In one embodiment of the present invention, administrative tasks are accomplished by multiple administrators. FIG. 2 illustrates the process of administrative task execution in accordance with one embodiment of the present invention. At step 200, an administrative task is scheduled for execution. At step 210, the responsible administrator is determined. At step 220, the responsible administrator executes the administrative task.

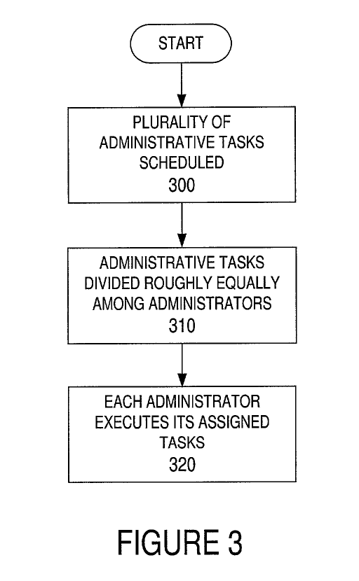

In one embodiment, the number of administrative tasks assigned to an administrator is approximately uniform throughout the computer system. FIG. 3 illustrates the process of administrative task execution in accordance with one embodiment of the present invention. At step 300, a plurality of administrative tasks are scheduled. At step 310, the administrative tasks are divided roughly equally among the administrators. In one embodiment administrative tasks are divided such that the standard deviation of the number of administrative tasks assigned to each administrator is less than some maximum allowable value. Other embodiments use other methods of dividing administrative tasks roughly equally among the administrators. At step 320, each administrator executes its assigned tasks.

In one embodiment, creation of multiple user accounts is accomplished by assigning each administrator a roughly equal number of user accounts to create. In another embodiment, workgroup administration is accomplished by assigning each administrator a roughly equal number of workgroups to administrate.

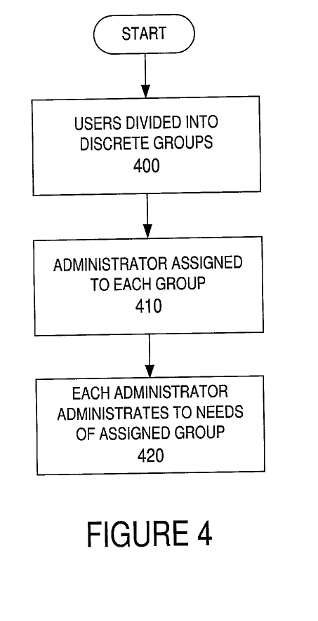

In another embodiment, each administrator is assigned to a group of users where multiple groups are each individually managed by their respective administrator. Each group comprises a discrete subset of the entire community of users where the group shares common needs within the system. For instance, each group may share common access rights, privileges, workgroup needs and access to information needs. This embodiment is shown in FIG. 4.

FIG. 4 illustrates administration of groups of users in accordance with one embodiment of the present invention. At step 400, the users are divided into discrete groups. At step 410, an administrator is assigned to each group. At step 420, each administrator administrates to the needs of its assigned group of users.

In one embodiment, students are users and teachers are administrators. In this embodiment, each teacher is responsible for creating user accounts for their students that lack accounts. Additionally, each teacher administrates workgroups which are related to the teacher's class.

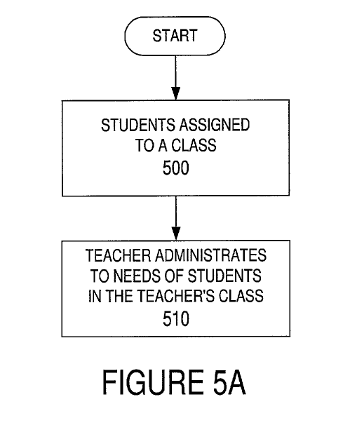

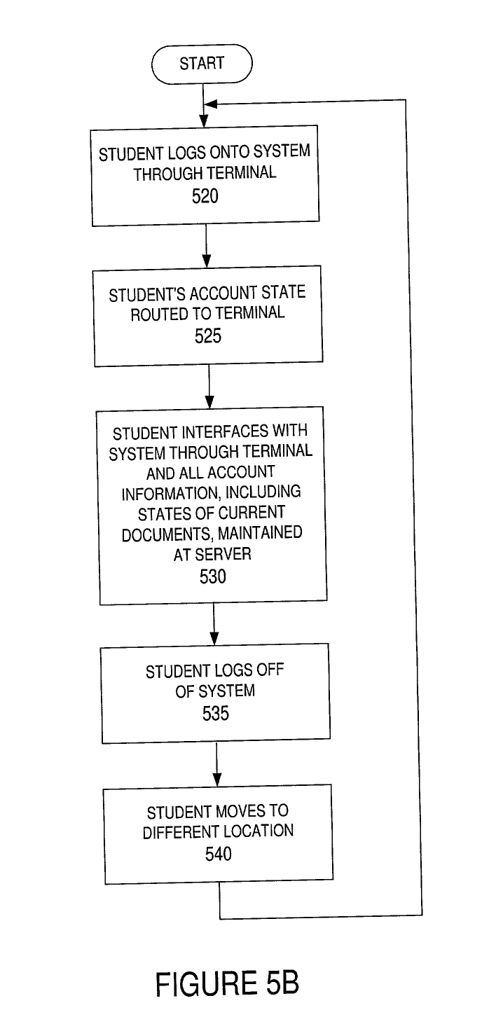

FIG. 5 illustrates systems administration in accordance with one embodiment of the present invention. At step 500, students are assigned to a class. At step 510, a teacher administrates to the needs of the students in the teacher's class.

In one embodiment, a user's account information is stored at one or more central locations. The user is able to access the account information from any terminal on the system. For example, a student could use the system from a terminal in one classroom, logout, move to another classroom, login to the system and resume working on the system. All the user's work is preserved and redirected to the new terminal.

FIG. 5B illustrates the process of accessing an account form multiple locations in accordance with one embodiment of the present invention. At step 520, a student logs onto the system through a terminal. At step 525, the student's account state is routed to the terminal. At step 530, the student interfaces with the system through the terminal and all the account information, including states of current documents, is maintained at the server. At step 535, the student logs off from the system. At step 540, the student moves to a different location and the process repeats at step 520.

Virtual Desktop System Architecture

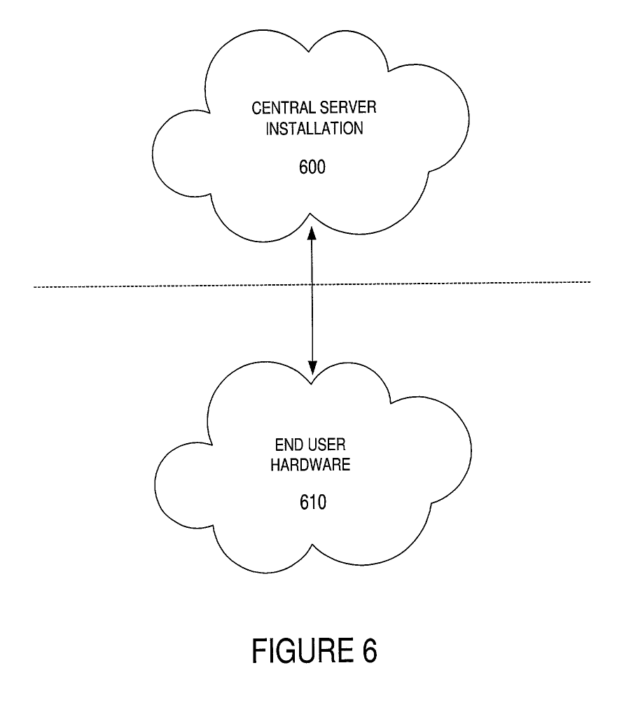

FIG. 6 shows an example of a thin client topology called a virtual desktop system architecture in accordance with one embodiment of the present invention. The virtual desktop system architecture provides a re-partitioning of functionality between a central server installation 600 and end user hardware 610. Data and computational functionality are provided by data sources via a centralized processing arrangement. At the user end, all functionality is eliminated except that which generates output to the user (e.g., display and speakers), takes input from the user (e.g., mouse and keyboard) or other peripherals that the user may interact with (e.g., scanners, cameras, removable storage, etc.). All computing is done by the central data source and the computing is done independently of the destination of the data being generated. The output of the source is provided to a terminal, referred to here as a “Human Interface Device” (HID). The HID is capable of receiving the data and displaying the data.

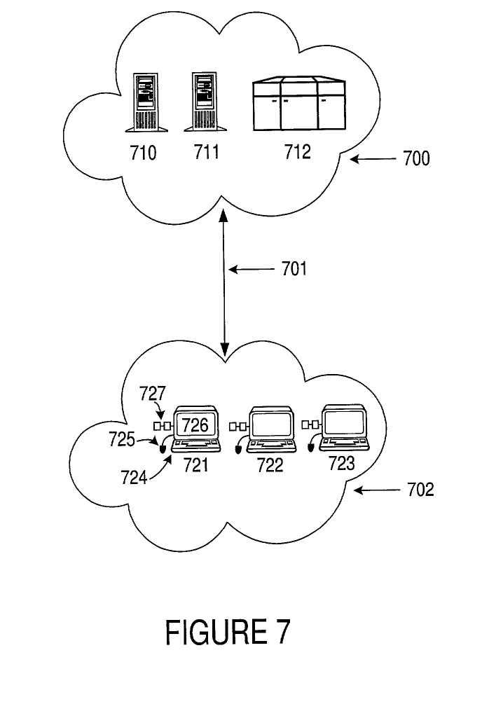

The functionality of the virtual desktop system is partitioned between a display and input device such as a remote system and associated display device, and data sources or services such as a host system interconnected to the remote system via a communication link. The display and input device is a human interface device (HID). The system is partitioned such that state and computation functions have been removed from the HID and reside on data sources or services. One or more services communicate with one or more HIDs through a communication link such as network. An example of such a system in accordance with the present invention is illustrated in FIG. 7, wherein the system comprises computational service providers 700 communicating data through communication link 701 to HIDs 702.

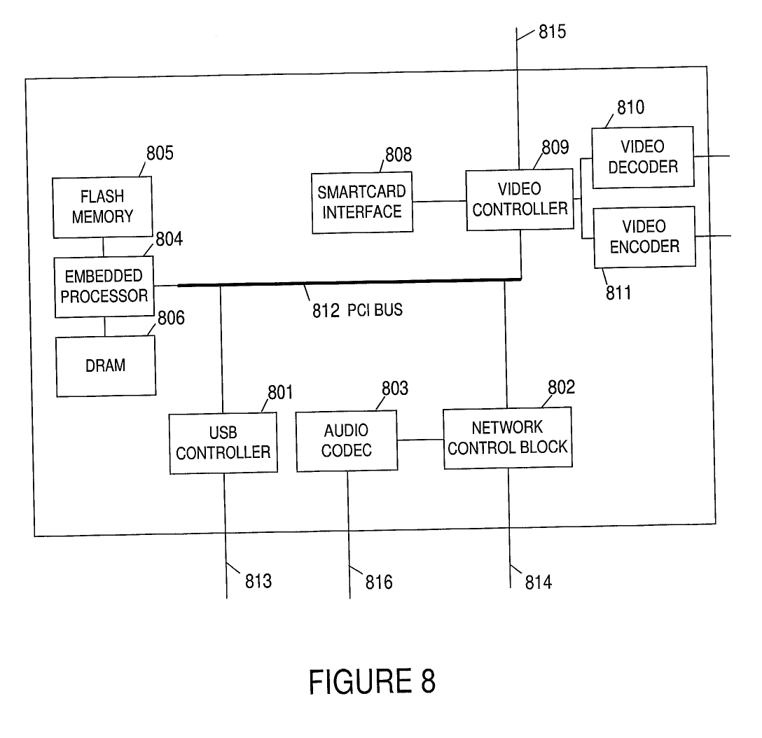

The computational power and state maintenance is provided by the service providers or services. The services are not tied to a specific computer, but may be distributed over one or more traditional desktop systems such as described in connection with FIG. 8, or with traditional servers. One computer may have one or more services, or a service may be implemented by one or more computers. The service provides computation, state and data to HIDs and the service is under the control of a common authority or manager. In FIG. 7, the services are provided by computers 710, 711, and 712. In addition to the services, a central data source can provide data to the HIDs from an external source such as for example the Internet or world wide web. The data source can also broadcast entities such as those that broadcast data such as television and radio signals.

Examples of services include X11/Unix services, archived or live audio or video services, Windows NT service, Java program execution service and others. A service herein is a process that provides output data and response to user requests and input. The service handles communication with an HID currently used by a user to access the service. This includes taking the output from the computational service and converting it to a standard protocol for the HID. The data protocol conversion is handled by a middleware layer, such as the X11 server, the Microsoft Windows interface, video format transcoder, the OpenGL interface, or a variant of the java.awt.graphics class within the service producer machine. The service machine handles the translation to and from a virtual desktop architecture wire protocol described further below.

Each service is provided by a computing device optimized for its performance. For example, an Enterprise class machine could be used to provide X11/Unix service, a Sun MediaCenter could be used to provider video service, and a Hydra based NT machine could provide applet program execution services.

The service providing computer system can connect directly to the HIDs through the interconnect fabric. It is also possible for the service producer to be a proxy for another device providing the computational service, such as a database computer in a three-tier architecture, where the proxy computer might only generate queries and execute user interface code.

The interconnect fabric can comprise any of multiple suitable communication paths for carrying data between the services and the HIDs. In one embodiment the interconnect fabric is a local area network implemented as an Ethernet network. Any other local network may also be utilized. The invention also contemplates the use of wide area networks, the Internet, the world wide web, and others. The interconnect fabric may be implemented with a physical medium such as a wire or fiber optic cable, or it may be implemented in a wireless environment.

The interconnect fabric provides actively managed, low-latency, high-bandwidth communication between the HID and the services being accessed. One embodiment contemplates a single-level, switched network, with cooperative (as opposed to completing) network traffic. Dedicated or shared communications interconnects maybe used in the present invention.

The HID is the means by which users access the computational services provided by the services. FIG. 7 illustrates HIDs 721, 722 and 723. Each HID comprises a display 726, a keyboard 724, mouse 725, and audio speakers 727. The HID includes the electronics need to interface these devices to the interconnection fabric and to transmit to and receive data from the services.

A block diagram of an example embodiment of the HID is illustrated in FIG. 8. The components of the HID are coupled internally to a PCI bus 812. A network control block 802 communicates to the interconnect fabric, such as an Ethernet, through line 814. An audio codec 803 receives audio data on interface 816 and is coupled to network control block 802. USB data communication is provided on lines 813 to a USB controller 801. The HID further comprises an embedded processor 804 such as a Sparc2ep with coupled flash memory 805 and DRAM 806. The USB controller 801, the network controller 802 and the embedded processor 804 are all coupled to the PCI bus 812. A video controller 809, also coupled to the PCI bus 812, can include an ATI RagePro+ frame buffer controller which provides SVGA output on the line 815. NTSC data is provided in and out of the video controller through video decoder 810 and encoder 811 respectively. A smartcard interface 808 may also be coupled to the video controller 809.

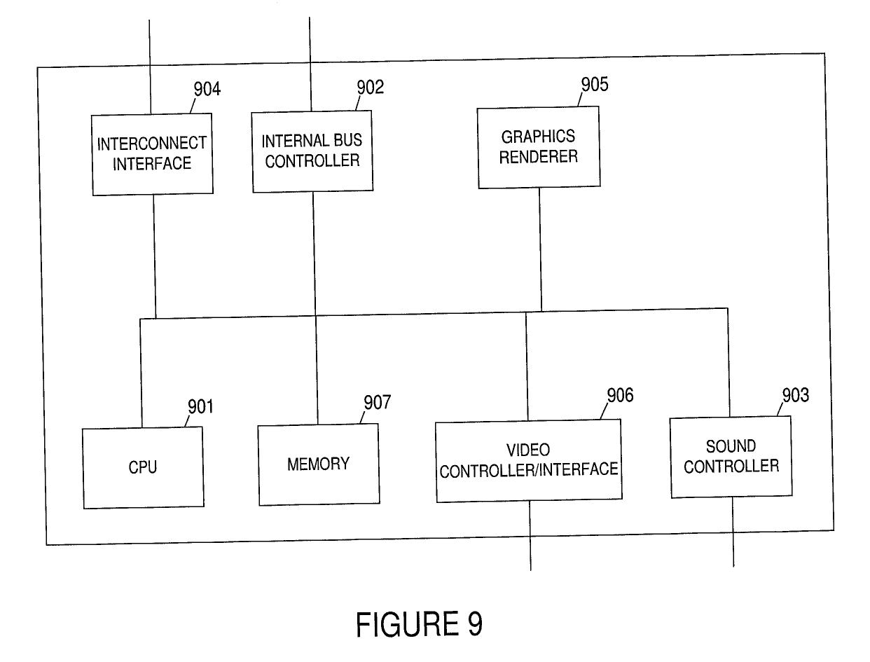

Alternatively, the HID can comprise a single chip implementation as illustrated in FIG. 9. The single chip includes the necessary processing capability implemented via CPU 901 and graphics renderer 905. Chip memory 907 is provided, along with video controller/interface 906. An internal bus (USB) controller 902 is provided to permit communication to a mouse, keyboard and other local devices attached to the HID. A sound controller 903 and interconnect interface 904 are also provided. The video interface shares memory 907 with the CPU 901 and graphics renderer 905. The software used in this embodiment may reside locally in on-volatile memory or it can be loaded through the interconnection interface when the device is powered.

The operation of the virtual desktop system architecture is described in copending U.S. patent application Ser. No. 09/063,335, filed Apr. 20, 1998, entitled “Method and Apparatus for Providing A Virtual Desktop System Architecture” and assigned to the present assignee, and incorporated herein by reference.

Embodiment of Computer Execution Environment (Hardware)

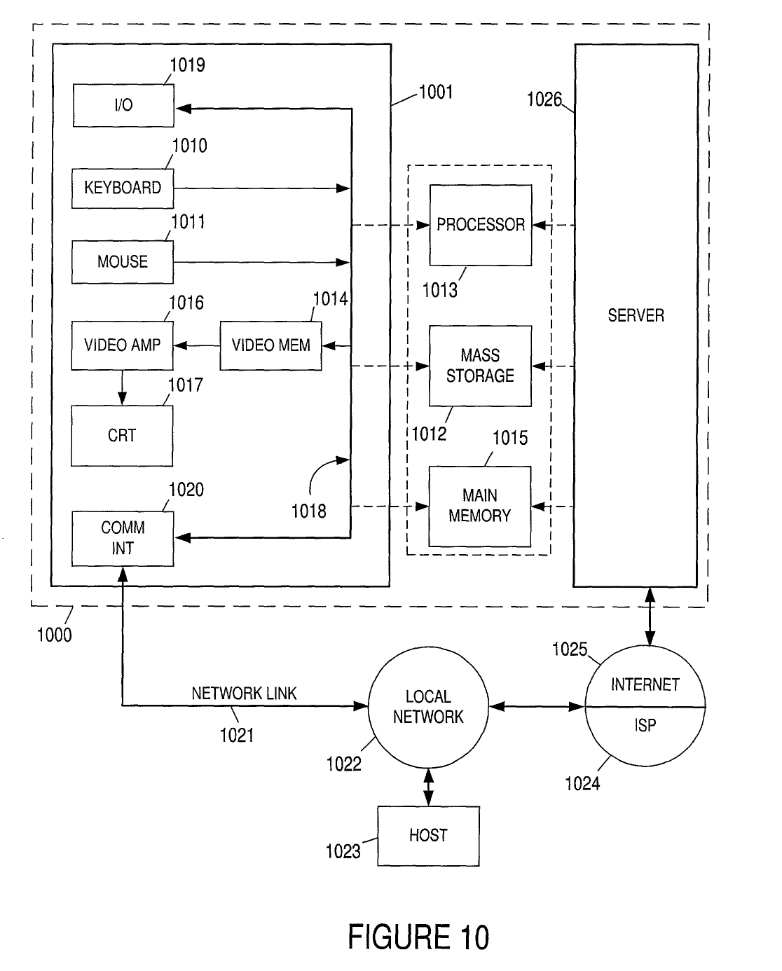

An embodiment of the invention can be implemented as computer software in the form of computer readable-program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU) 1013. Other suitable input devices may be used in addition to, or in place of, the mouse 1011 and keyboard 1010. I/O (input/output) unit 1019 coupled to bidirectional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013. As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a SPARC microprocessor from Sun Microsystems, Inc., a microprocessor manufactured by Motorola, such as the 680X0 processor, or a microprocessor manufactured by Intel, such as the 80X86 or Pentium processor. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code may be executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for distributed administration of thin client architecture is described in conjunction with one or more specific embodiments. The invention is defined by the following claims and their fall scope and equivalents.

1. A method for administration of a thin client architecture comprising:
providing a plurality of administrators;
distributing a plurality of administrative tasks among said administrators; and
executing said administrative tasks.

2. The method of claim 1 wherein said step of distributing comprises:
dividing said administrative tasks into a plurality of task groups wherein a first number of said task groups is equal to a second number of said administrators.

3. The method of claim 2 wherein said step of dividing comprises:
assigning said administrative tasks to said task groups wherein a standard deviation of the number of said administrative tasks in each task group is less than a fourth number.

4. The method of claim 1 wherein said administrative tasks are user account creation tasks.

5. The method of claim 1 wherein said administrative tasks are workgroup administration tasks.

6. The method of claim 1 wherein said administrators are educators.

7. The method of claim 1 further comprising:
storing an account state for a user; and
routing said account state to a terminal wherein said user is logged into said terminal.

8. An administration system for a thin client architecture comprising:
a plurality of administrators;
a distribution mechanism configured to distribute a plurality of administrative tasks among said administrators; and
a task execution device configured to enable said administrators to execute said administrative tasks.

9. The administration system of claim 8 wherein said distribution mechanism is further configured to divide said administrative tasks into a plurality of task groups wherein a first number of said task groups is equal to a second number of said administrators.

10. The administration system of claim 9 wherein said distribution mechanism is further configured to assign said administrative tasks to said task groups wherein a standard deviation of the number of said administrative tasks in each task group is less than a fourth number.

11. The administration system of claim 8 wherein said administrative tasks are user account creation tasks.

12. The administration system of claim 8 wherein said administrative tasks are workgroup administration tasks.

13. The administration system of claim 8 wherein said administrators are educators.

14. The administration system of claim 8 further comprising:
a storage unit configured to store an account state for a user; and
a router configured to route said account state to a terminal wherein said user is logged into said terminal.

15. A computer program product comprising:
a computer usable medium having computer readable program code embodied therein configured for administration of a thin client architecture, comprising:
computer readable code configured to cause a computer to provide a plurality of administrators;
computer readable code configured to cause a computer to distribute a plurality of administrative tasks among said administrators; and
computer readable code configured to cause a computer to enable said administrators to execute said administrative tasks.

16. The computer program product of claim 15 wherein said computer readable code configured to cause a computer to distribute comprises:
computer readable code configured to cause a computer to divide said administrative tasks into a plurality of task groups wherein a first number of said task groups is equal to a second number of said administrators.

17. The computer program product of claim 16 wherein said computer readable code configured to cause a computer to divide comprises:
computer readable code configured to cause a computer to assign said administrative tasks to said task groups wherein a standard deviation of the number of said administrative tasks in each task group is less than a fourth number.

18. The computer program product of claim 15 wherein said administrative tasks are user account creation tasks.

19. The computer program product of claim 15 wherein said administrative tasks are workgroup administration tasks.

20. The computer program product of claim 15 wherein said administrators are educators.

21. The computer program product of claim 15 further comprising:
computer readable code configured to cause a computer to store an account state for a user; and
computer readable code configured to cause a computer to route said account state to a terminal wherein said user is logged into said terminal.
